(19) United States
(12) Patent Application Publication
(10) Pub. No.: US 2012/0118656 A1
(43) Pub. Date: May 17, 2012

(54) Seal lip on vane

(75) Inventors: Steven R. Roddy, Harrison Township, MI (US); Christopher J. Kuntze, Clarkston, MI (US); William B. Zywicki, JR., White Lake, MI (US); James J. Kowalski, Lake Orion, MI (US)

(73) Assignee: Magna International Inc., Aurora (CA)

(21) Appl. No.: 13/373,198

(22) Filed: Nov. 8, 2011

Related U.S. Application Data
(60) Provisional application No. 61/456,503, filed on Nov. 8, 2010.

(51) Int. Cl. B60K 11/06; B60H 1/24

(52) U.S. Cl. 180/68.1; 454/152

(57) ABSTRACT

An extruded or molded seal lip which is connected to a vane or louver as a secondary operation during the assembly process, where the seal and louver have connectors suitable for providing a secure connection between the louver and the seal. The louver is part of a group of louvers which function as active ducting for an automobile. Each louver has at least one seal, with one seal from one louver contacting a corresponding louver for preventing airflow through the aperture of a carrier. The seal may be attached to the louver along the face of the louver, or be attached by sliding the louver into a groove formed as part of the louver, or sliding the louver into a groove formed as part of the seal.

### CROSS-REFERENCE TO RELATED APPLICATIONS

This application claims priority to U.S. Provisional Application No. 61/456,503 filed on Nov. 8, 2010. The disclosure of the above application is incorporated herein by reference.

### FIELD OF THE INVENTION

The present invention relates to a seal which is attached to a vane, where the vane is part of a set of movable vanes connected to the carrier of an automobile.

### BACKGROUND OF THE INVENTION

Various attempts have been made to optimize the cooling of various automobile parts. Some of the various devices developed have been designed to control the air flow throughout the engine compartment of the automobile such that the desired amount of heat is transferred away from the engine, transmission, and other components which generate heat in order to maintain an optimal operating temperature.

However, it is also desirable to bring the engine up to the normal operating temperature as soon as possible after engine start-up. When the engine is substantially the same temperature as the surrounding environment and is turned on, the engine is the least fuel efficient (especially during start-up and the temperature of the surrounding environment is cold). The reduced fuel efficiency is why it is considered desirable to bring the engine up to the optimal operating temperature very quickly. Under these conditions, it is not desirable to remove heat away from the engine and the various components surrounding the engine, and therefore devices designed to control air flow around the engine are more beneficially used if they do not remove heat away from the engine at start-up.

Furthermore, components designed to provide optimal cooling when the vehicle is new may operate differently after the vehicle has accumulated significant mileage. This may occur due to various weather conditions, changes in the way the vehicle is operated in response to different drivers, or wear and tear on the vehicle components and other components. All of these factors may affect or change the operation of the components over time as the vehicle accumulates mileage. Also, with many current cooling systems, the airflow generated from the forward motion of a vehicle is not efficiently used to cool the various components of the vehicle. Rather, many of the components of a vehicle cause poor airflow which leads to aerodynamic inefficiencies.

One particular attempt at this type of cooling is the use of louvers which are moveable between various positions to manipulate the air flow around the various components underneath the hood of the automobile. These louvers may also be equipped with a type of sealing element to provide a seal between the louvers, further preventing any unwanted airflow into the engine compartment when the louvers are in the closed position. Many types of louvers are created using an extrusion process which allows for the seal to be coextruded with the louver. However, some types of louvers must be created using a molding process, due to various assembly requirements, which does not allow for the louver and the seal to be extruded together.

Accordingly, there exists a need for a louver system attached to the carrier or other component of a vehicle which has a seal that is easily and securely connectable to the louver, when the louver is made using a molding process.

### SUMMARY OF THE INVENTION

The present invention is directed to an extruded or molded seal lip which is connected to a vane or louver as a secondary operation during the assembly process, where the seal and louver have connectors suitable for providing a secure connection between the louver and the seal. The louver is part of a group of louvers which function as active ducting for an automobile.

More particularly, each louver has at least one seal, with the seal from one louver contacting a corresponding louver for preventing airflow through the aperture of a carrier. The seal, may be attached to the louver along the face of the louver, or be attached by sliding the louver into a groove formed as part of the louver, or sliding the louver into a groove formed as part of the seal. In one embodiment, each seal includes a slip coat for reducing the friction between the seals, as well as limiting binding between the louvers from ice formation on the surface of the seals, and improving wear resistance to dirt and debris during cycling.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional side view of a first embodiment of a louver having a seal, according to the present invention;

FIG. 2 is a perspective view of a first embodiment of a louver having a seal, according to the present invention;

FIG. 3 is an enlarged perspective view of a first embodiment of a louver having a seal, according to the present invention;

FIG. 4 is a sectional front view of a first embodiment of a louver having a seal, according to the present invention;

FIG. 5 is a perspective view of a second embodiment of a louver having a seal, with the seal removed and the louver having no side walls, according to the present invention;

FIG. 6 is a perspective view of a second embodiment of a seal used as part of a louver having a seal, with the louver having no side walls, according to the present invention;

FIG. 7 is a sectional side view of a third embodiment of a louver having a seal, and the louver having no side walls, according to the present invention;

FIG. 8A is a side view of a third embodiment of a louver having a seal, and the louver having no side walls, according to the present invention;

FIG. 8B is a perspective view of a third embodiment of a louver having a seal, and the louver having no side walls, according to the present invention;

FIG. 8C is a perspective view of a first embodiment of a louver having a seal, according to the present invention;

FIG. 8D is another perspective view of the first embodiment of a louver having a seal, according to the present invention;

FIG. 9A is an enlarged sectional view of a fourth embodiment of a louver having a seal, with the louver having no side walls, according to the present invention;

FIG. 9B is a sectional view of a fourth embodiment of a louver having a seal, with the louver having no side walls, according to the present invention;

FIG. 10A is a first sectional view of a fifth embodiment of a louver having a seal, according to the present invention;

FIG. 10B is a second sectional view of a fifth embodiment of a louver having a seal, according to the present invention;

FIG. 10C is a third sectional view of a fifth embodiment of a louver having a seal, according to the present invention;

FIG. 11A is a partial bottom view of a fifth embodiment of a louver having a seal, with the seal removed, according to the present invention; and

FIG. 11B is a partial bottom view of a fifth embodiment of a louver having a seal, according to the present invention.

### DETAILED DESCRIPTION OF THE PREFERRED EMBODIMENTS

The following description of the preferred embodiment(s) is merely exemplary in nature and is in no way intended to limit the invention, its application, or uses.

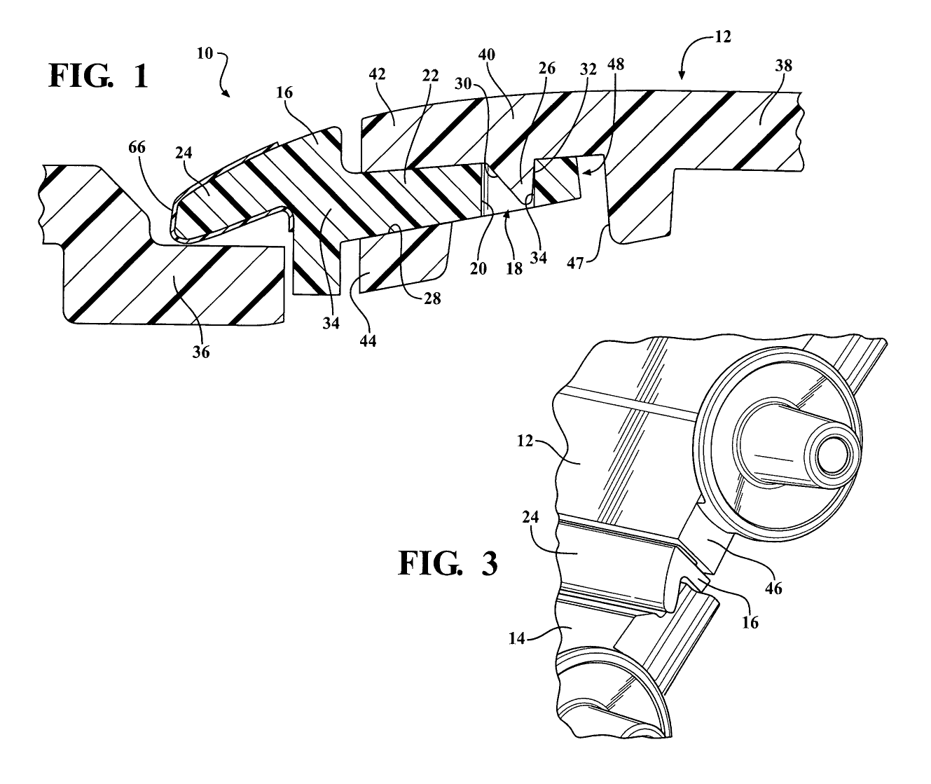

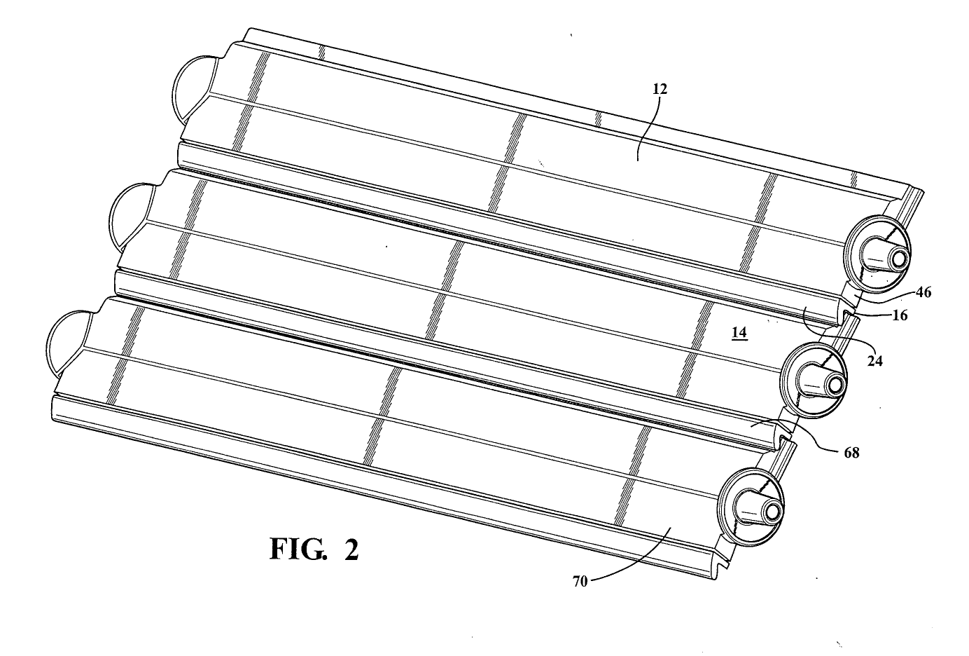

A first embodiment of the present invention is shown in FIGS. 1-4 and 8C-8D. More specifically, a louver or vane having a seal with a retention feature according to the present invention is shown generally at 10. There is a first louver, shown generally at 12, and a second louver, shown generally at 14, which are adjacent one another and make up a system of louvers used for controlling the flow of air through an engine compartment of a vehicle. While the present embodiment describes two louvers 12,14, it is within the scope of the invention that the system of louvers may have more than two louvers.

Attached to the first louver 12 is a first seal 16, which is connected to the first louver 12 through a retention feature, generally shown at 18. The retention feature 18 includes a first aperture 20 formed as part of a base portion 22 of the seal 16. The seal 16 also includes a lip 24 for selectively contacting the second louver 14, best seen in FIG. 1. Also formed as part of the retention feature 18 and selectively disposed within the first aperture 20 is a flange 26; the flange 26 is formed as part of the first louver 12. During assembly, the base portion 22 of the seal 16 is inserted into a second aperture 28 formed as part of the first louver 12. The base portion 22 is pressed into the second aperture 28 such that the base portion 22 deflects the flange 26 (building tension in the flange 26) until the first aperture 20 is substantially aligned with the flange 26, at which point the tension in the flange 26 is released, and the flange 26 slides into the first aperture 20. Once the flange 26 is disposed in the first aperture 20, the seal 16 is prevented from becoming detached from the first louver 12. This essentially provides a snap-fit connection between the seal 16 and the louver 12.

The flange 26 includes an angled surface 30 and a retention surface 32. As the base portion 22 is slid into the first aperture 20, the base portion 22 slides along the angled surface 30, deflecting the flange 26. The angled surface 30 allows for the flange 26 to be more easily deflected as the base portion 22 moves through the aperture 20. Once the flange 26 is disposed in the first aperture 20, the retention surface 32 contacts an inner surface 34 of the first aperture 20, retaining the first louver 12 in connection with the seal 16. The flange 26 does not extend the entire length of the louver 12, but rather there are several flanges 26 spaced apart from one another along the length of the louver 12, and there are also several apertures 20 spaced along the length of the seal 16 which correspond to each of the flanges 26. The second aperture 28 does extend almost the entire length of the louver 12 for receiving the base portion 22 which is slightly shorter than the length of the louver 12.

Adjacent and integrally formed with the base portion 22 is a body portion 34, and extending away from the body portion 34 is the lip 24. As mentioned above, the lip 24 is selectively in contact with the second louver 14. More specifically, the lip 24 is in contact with a rear portion 36 of the second louver 14 when the louvers 12,14 are in a closed position.

Each of the louvers 12,14 has the rear portion 36, and the rear portion 36 is integrally formed with a central portion 38. Each louver 12,14 also includes a front portion 40 which is also integrally formed as part of the central portion 38. The front portion 40 is made up of two flanges, an upper flange 42 and a lower flange 44. As mentioned above, there may be one or more flanges 26, and each of the flanges 26 is integrally formed with the upper flange 42. The second aperture 28 is between the two flanges 42,44, and the lower flange 44 has a third aperture 47. The third aperture 47 also does not extend the entire length of the louver 12, but rather there are several of the apertures 47 spaced along the lower flange 44. The flanges 42,44 form a cavity, shown generally at 48, the base portion 22 extends through the aperture 28 into the cavity 48, and is located in the cavity 48 when the louver 12 and seal 16 are connected together.

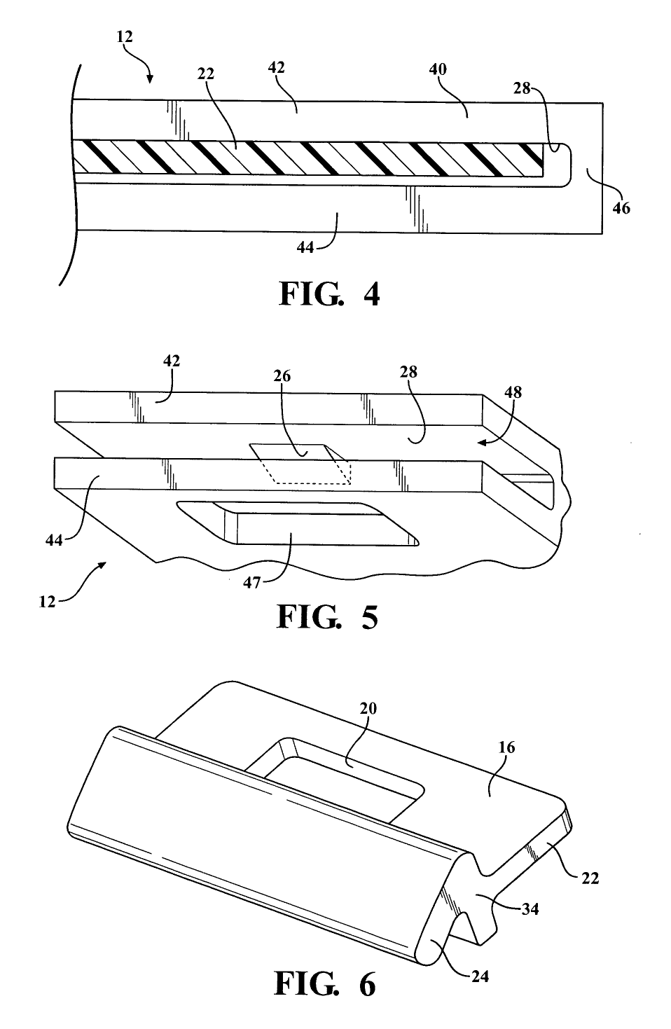

The seal 16 is made from a TPV (Thermoplastic Vulcanizate) which is extruded to correspond to the length of the louvers 12,14. In this embodiment, the seals 16 are extruded such that the lip 24 is of a length substantially equal to the louver 12, and as mentioned above, the base portion 22 is of a length that is shorter than the length of the louver 12. This louver 12 in this embodiment also has sidewalls 46, which provide at least one closed end, best seen in FIGS. 3-4. The seal 16 undergoes a finishing operation after extrusion to not only cut the seal 16 to the desired length, but also to form one or more of the apertures 20 and shape the base portion 22 to fit into the corresponding apertures 28 of the louver 12. As mentioned above, there may be multiple apertures 20 and multiple flanges 26, depending upon the length of the louver 12 and the length of the seal 16.

In a second embodiment, shown in FIGS. 5-6, the louver 12 does not have the sidewalls 46, and each end is an open end. In this embodiment, the seal 16 is similar to the seal shown in the first embodiment, with the exception that the base portion 22 extends the entire length of the louver 12. The seal 16 still connects to the louver 12 in a similar manner as described with the first embodiment.

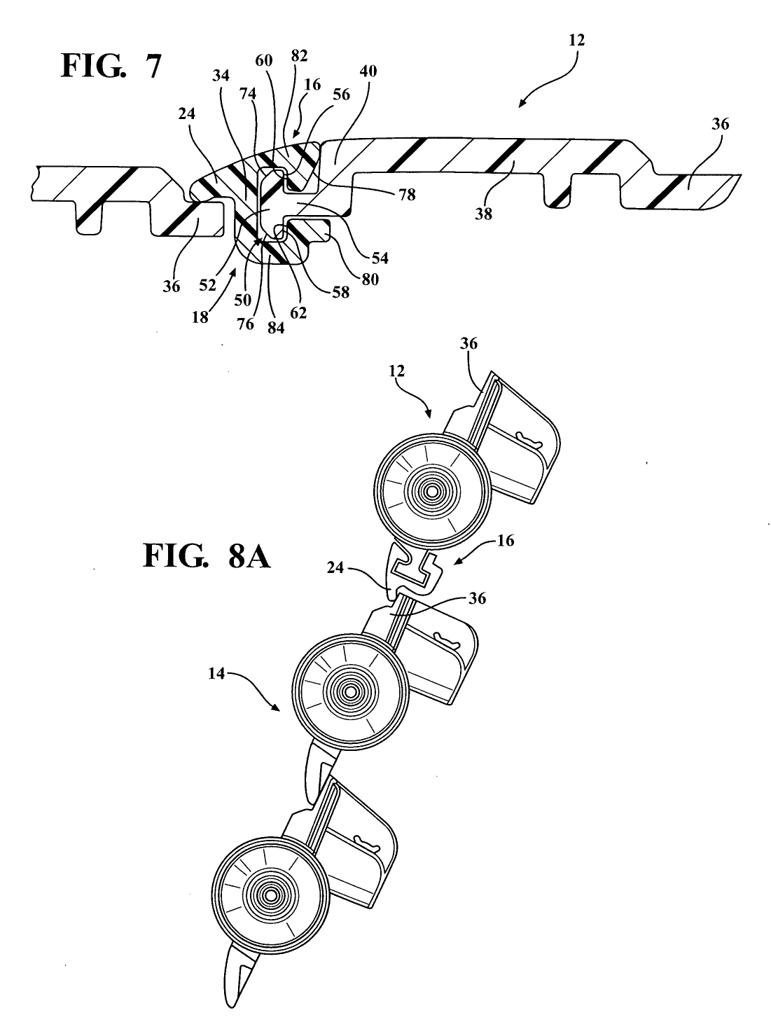

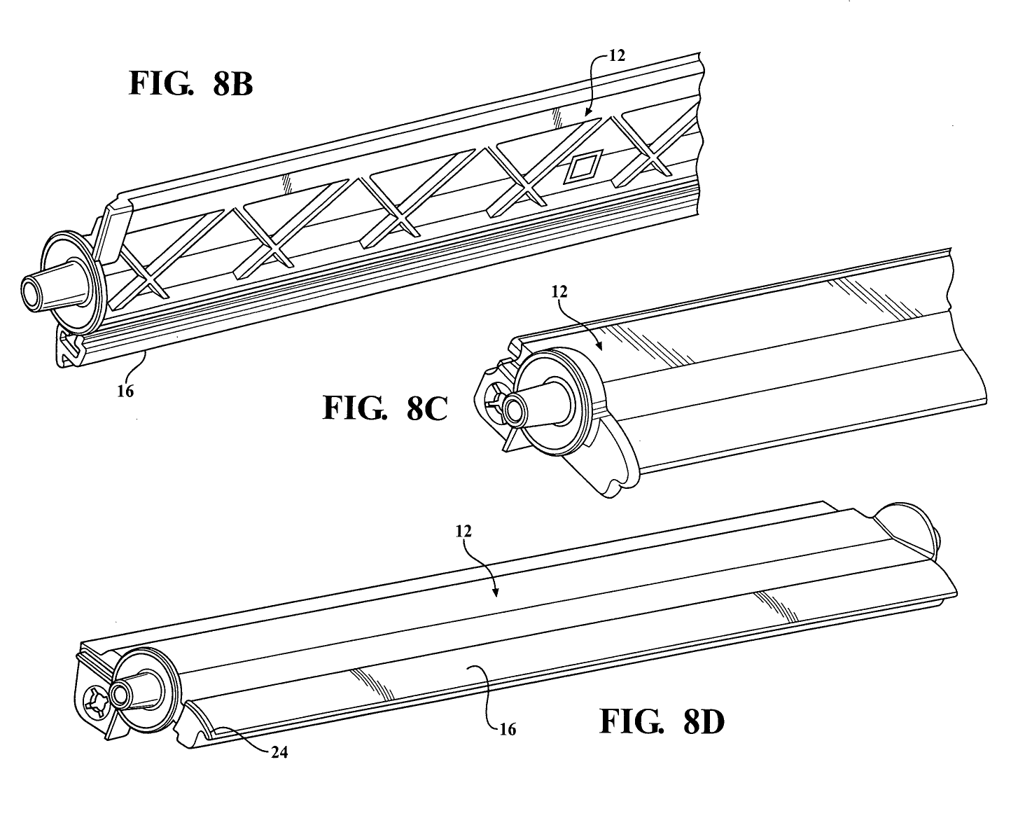

In a third embodiment, shown in FIGS. 7-8B, the seal 16 has the lip 24 and body portion 34, but the seal 16 does not include the base portion 22. In this embodiment, the retention feature 18 includes a groove, shown generally at 50, formed as part of the seal 16, and the groove 50 is operable to retain the louver 14. The louver 14 slides into the groove 50 during assembly. The front portion 40 has a retaining flange 52 which is substantially perpendicular to an extension 54, generally forming a T-shape, and the retaining flange 52 and extension 54 are also part of the retention feature 18 in this embodiment. The groove 50 of the seal 16 in this embodiment has a general C-shape, which corresponds to the T-shape created by the flange 52 and the extension 54. The retaining flange 52 has an upper rear surface 56 and a lower rear surface 58. The groove 50 includes an upper backing surface 60 and a lower backing surface 62. When assembled, the upper backing surface 60 is in contact with the upper rear surface 56, and the lower backing surface 62 is in contact with the lower rear surface 58, preventing the seal 16 from being detached from the louver 14. The retaining flange 52 also includes an upper ramp surface 74 and a lower ramp surface 76, and the seal 16 also has an outer ramp surface 78 formed as part of an upper half 82, and an outer flange 80 formed as part of a lower half 84 of the seal 16.

As an alternative to sliding the louver 14 into the groove 50 during assembly, the louver 14 and seal 16 in this embodiment may also snap-fit together. The seal 16 is made of a resilient elastomeric material which allows retention of its original shape after deflection over the retaining flange 52 of the louver 12. This is achieved by simply laterally pressing the outer ramp surface 78 against the upper ramp surface 74, and pressing the outer flange 80 against the lower ramp surface 76 such that each half 82,84 of the seal 16 deflects automatically, allowing the retention flange 52 to locate in the groove 50.

Alternatively, the groove 50 may be formed as part of the louver 12, and the retaining flange 52 and extension 54 may be formed as part of the seal 16.

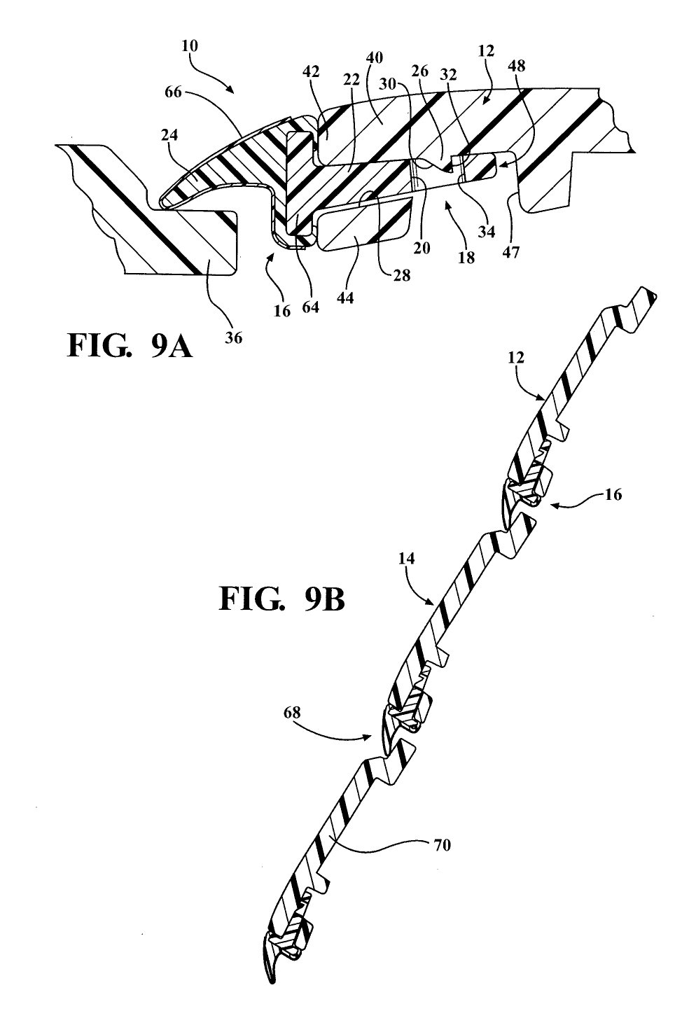

A fourth embodiment of the invention is shown in FIGS. 9A-9B, which is similar to the first embodiment, with like numbers referring to like elements. In this embodiment, the base portion 22 is formed as a separate component from the body portion 34 and the lip 24. The base portion 22 is a polypropylene and the body portion 34 and lip 24 are made of a TPV material; the base portion 22 and body portion 34 are extruded together, and then assembled to the louver 12. In this embodiment, the base portion 22 includes an outer flange 64 which the body portion 34 is extruded onto, securing the connection between the base portion 22 and the body portion 34.

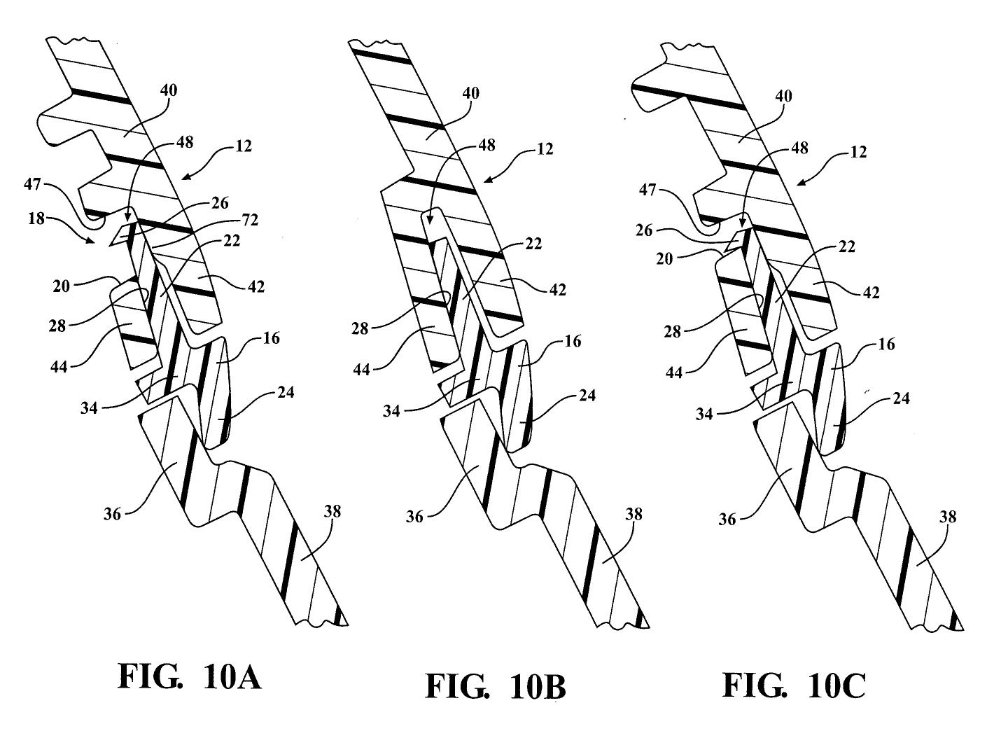

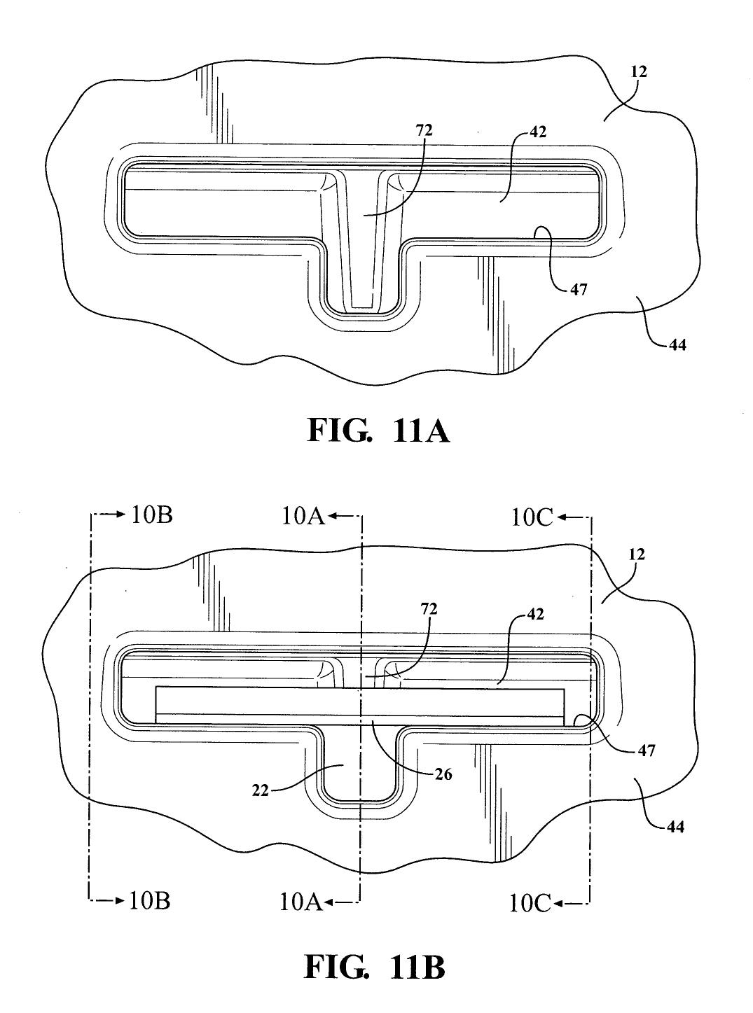

A fifth embodiment of the present invention is shown in FIGS. 10A-11B. The fifth embodiment is similar to the first embodiment, with like numbers referring to like elements. In this embodiment, however, the flange 26 is formed as part of the base portion 22, and extends into the aperture 47 when the seal 16 is attached to the louver 12, preventing the seal, 16 from being detached from the louver 12. Also formed as part of the upper flange 42 of the louver 12 is a detent feature 72 which as seen in FIG. 10A contacts the base portion 22, and provides positioning of the seal 16 relative to the louver 12.

In each of the embodiments described above, the seal 16 also may include a slip coat 66 which reduces friction between the seal 16 and the adjacent louver 14, or adjacent seal 16 if the adjacent louver 14 also includes a seal 16. The slip coat 66 may be extruded along with the seal 16, or may be applied to the seal 16 as part of a separate operation.

As mentioned above, there is a first louver 12 having a first seal 16, along with a second louver 14. It is within the scope of the invention that a second seal 68 may be used along with a third louver 70. It is also within the scope of the invention that more or less than the three louvers 12,14,70 and seals 16,68 may be used, depending upon the operating requirements of the vehicle.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A system of louvers, comprising:
a plurality of louvers operable for changing between an open position and a closed position;
at least one seal connected to a first of said plurality of louvers; and
at least one retention feature connecting said at least one seal to said first of said plurality of louvers;
wherein said at least one seal provides a sealing function between said first of said plurality of louvers and a second of said plurality of louvers when said plurality of louvers are in a closed position.

2. The system of louvers of claim 1, said at least one retention feature further comprising:
a first aperture formed as part of said at least one seal; and
a flange formed as part of said first of said plurality of louvers;
wherein said flange is disposed in said first aperture when said at least one seal is connected to said first of said plurality of louvers.

3. The system of louvers of claim 1, said at least one retention feature further comprising:
a flange formed as part of said at least one seal; and
a first aperture formed as part of said first of said plurality of louvers;
wherein said flange is disposed in said aperture when said at least one seal is connected to said first of said plurality of louvers.

4. The system of louvers of claim 1, each of said plurality of louvers further comprising;
a central portion;
a rear portion integrally formed with said central portion;
a front portion integrally formed with said central portion;
a cavity formed as part of said front portion; and
an aperture formed as part of said front portion, said at least one seal extends through said aperture and is partially disposed in said cavity when said at least one seal is connected to said first of said plurality of louvers.

5. The system of louvers of claim 4, said front portion further comprising:
an upper flange integrally formed with said central portion; and
a lower flange integrally formed with said central portion, wherein said upper flange and said lower flange form said aperture and said cavity.

6. The system of louvers of claim 5, said front portion further comprising at least one side wall connected to said upper flange and said lower flange, for providing at least one closed end.

7. The system of louvers of claim 6, further comprising at least one open end formed by said upper flange and said lower flange.

8. The system of louvers of claim 5, said at least one seal further comprising:
a body portion;
a base portion integrally formed with said body portion, said base portion operable for being at least partially extending through said aperture formed as part of said front portion and into said cavity; and
a lip portion integrally formed with said body portion;
wherein said lip portion is in contact with a second of said plurality of louvers when said plurality of louvers are in said closed position.

9. The system of louvers of claim 8, wherein said base portion and said body portion are separate components and are coextruded together.

10. The system of louvers of claim 8, said lip further comprising a slip coat applied to said lip portion, said slip coat reduces friction between said first seal and said second louver.

11. The system of louvers of claim 1, said at least one retention feature further comprising:
a groove formed as part of said first seal; and
a retention flange formed as part of said first of said plurality of louvers;
wherein said retention flange is disposed in said groove when said first seal is connected to said first of said plurality of louvers.

12. A system of louvers, comprising:
a first louver;
a second louver operable with said first louver for changing between an open position and a closed position;
at least one seal connected to said first louver such that said at least one seal is in contact with said second louver when said first louver and said second louver are in said closed position;
at least one retention feature connecting said at least one seal to said first louver; and
a slip coat attached to said at least one seal and in contact with said second louver when said first louver and said second louver are in said closed position, said slip coat reducing friction between said first seal and said second louver.

13. The system of louvers of claim 12, further comprising:
a lip formed as part of said at least one seal; and
a rear portion formed as part of said second louver;
wherein said lip is in contact with said rear portion when said first louver and said second louver are in said closed position.

14. The system of louvers of claim 13, wherein said slip coat is applied to said lip.

15. The system of louvers of claim 12, each of said first louver and said second louver further comprising:
an upper flange;
a lower flange;
an aperture formed by said upper flange and said lower flange; and
a cavity formed by said upper flange and said lower flange, such that a portion of said at least one seal extends through said aperture into said cavity.

16. The system of louvers of claim 15, further comprising at least one side wall connected to said upper flange and said lower flange, said side wall providing at least one closed end.

17. The system of louvers of claim 15, further comprising at least one open end formed by said upper flange and said lower flange.

18. The system of louvers of claim 15, said first seal further comprising a base portion extending through said aperture and into said cavity.

19. The system of louvers of claim 18, said at least one seal further comprising a body portion, wherein said base portion and said body portion are separate components, and are coextruded together during assembly.

20. The system of louvers of claim 18, said at least one retention feature further comprising:
an aperture formed as part of said base portion; and
a flange formed as part of said first louver;
wherein said at least one seal is connected to said first louver when said flange formed as part of said first louver is disposed in said aperture formed as part of said base portion.

21. The system of louvers of claim 18, said at least one retention feature further comprising:
an aperture formed as part of said first louver; and
a flange formed as part of said base portion;
wherein said at least one seal is connected to said first louver when said flange formed as part of said base portion is disposed in said aperture formed as part of said first louver.

22. The system of louvers of claim 18, said at least one retention feature further comprising:
a groove formed as part of said first seal; and
a retention flange formed as part of said base portion;
wherein said retention flange is disposed in said groove when said first seal is connected to said first of said plurality of louvers.

23. A system of louvers for controlling the flow of air through an engine compartment of a vehicle, comprising:
a first louver;
a second louver operable with said first louver for changing between an open position and a closed position;
a first seal connected to said first louver, said first seal in contact with said second louver when said first louver and said second louver are in said closed position; and
a retention feature for connecting said first seal to said first louver.

24. The system of louvers of claim 23, said first louver further comprising:
a central portion;
a rear portion integrally formed with said central portion;
a front portion integrally formed with said central portion;
an upper flange being part of said front portion; and
a lower flange being part of said front portion, said upper flange and said lower flange forming a cavity, a portion of said first louver extending into said cavity.

25. The system of louvers of claim 24, further comprising at least one side wall connected to said upper flange and said lower flange, said side wall providing at least one closed end.

26. The system of louvers of claim 24, further comprising at least one open end formed by said upper flange and said lower flange.

27. The system of louvers of claim 23, said first seal further comprising:
a body portion;
a base portion integrally formed with said body portion, said base portion extending into said cavity formed by said upper flange and said lower flange;
a lip integrally formed with said body portion, said lip in contact with said second louver when said first louver and said second louver are in a closed position; and
a first aperture formed as part of said base portion;
wherein said first aperture receives a flange formed as part of said first louver, connecting said first seal to said first louver.

28. The system of louvers of claim 27, wherein said retention feature includes said flange formed as part of said first louver and said first aperture formed as part of said first seal.

29. The system of louvers of claim 27, said lip further comprising a slip coat applied to said lip, said slip coat for reducing friction between said first seal and said second louver.

30. The system of louvers of claim 23, said retention feature further comprising:
a groove formed as part of said first seal; and
a retention flange formed as part of said first louver;
wherein said retention flange is disposed in said groove when said first seal is connected to said first louver.

31. The system of louvers of claim 23, further comprising:
a second seal connected to said second louver; and
a third louver operable with said first louver and said second louver for changing between said open position and said closed position;
wherein said second seal is in contact with said third louver when said first louver, said second louver, and said third louver are in said closed position.
